(19) United States
(12) Patent Application Publication
(10) Pub. No.: US 2009/0244917 A1
(43) Pub. Date: Oct. 1, 2009

(54) AUTOMOTIVE INTERIOR COMPONENT COMBINING LIGHT AND MOVEMENT

(75) Inventors: Daniel W. Davie, West Bloomfield, MI (US); Gregg S. Evans, Windsor (CA); Crystufer C. Reed, Flint, MI (US)

Correspondence Address: Dykema Gossett PLLC - Los Angeles, CA, 333 S. Grand Avenue, Suite 2100, Los Angeles, CA, 90071, US

(73) Assignee: Intertec Systems, LLC, Troy, MI (US)

(21) Appl. No.: 12/412,098

(22) Filed: Mar. 26, 2009

Related U.S. Application Data
(60) Provisional application No. 61/039,945, filed on Mar. 27, 2008.

(51) Int. Cl. B60Q 1/26; H01J 9/00

(52) U.S. Cl. 362/488; 445/23

(57) ABSTRACT

The invention provides for an automotive interior component and method of making the same. The automotive interior component comprises a dock for receiving an object, a holder for receiving the dock and configured to movably store the dock, and a light source operatively connected to the dock. The light source provides continuous illumination of the dock as the dock moves from the holder to a deployed position, allowing ease of visible location and augmenting visual appeal of an automotive interior.

### CROSS-REFERENCE TO RELATED APPLICATION

This application claims the benefit of provisional patent application U.S. Ser. No. 61/039,945, filed Mar. 27, 2008, which is expressly incorporated herein by reference.

### BACKGROUND

a. Field of Invention

The invention relates generally to automotive interior components such as digital audio player docks and cell phone holders, and more specifically, to an apparatus and method for an automotive interior component combining motion deployment and lighting.

b. Description of Related Art

Automotive interior components are often produced in a variety of manufacturing sequences based on the assembly requirements set forth by a manufacturer and are also produced to a variety of specifications based on the quality and appearance expected by customers. Namely, customers expect the automobile interior components to be visually appealing while also providing functionality. Visually appealing features may include utilization of various textures and materials. More recently, visually appealing features have come to include creative integration of light sources.

It is known that automobile drivers and passengers may enter an automotive vehicle with items that are utilized during driving, and as such, a variety of known automotive interior components have been developed and are utilized for the storage and containment of such items. Automotive interior components with receptacle functionality may include such components as digital audio player docks such as MP3 player docks, cell phone holders, and/or similar receptacle components.

For example, U.S. Pat. No. 5,803,421 to Kerner et al. discloses a cup holder with a housing that is integrated into a center console of a passenger car, and with a supporting carriage which is disposed in the housing and can be moved out of the housing by means of a linear guide along a limited moving range and which is provided with receiving devices for two beverage containers, in which case the supporting carriage can be fixed in a first operating position of the moving range in which an individual beverage container can be accommodated, as well as in a second operating position of the moving range in which both beverage containers can be accommodated. However, the cup holder of Kerner et al. does not provide a location indicator for the driver or passenger to efficiently and safely locate the cup holder and does not augment the visual appeal of the automotive interior.

It would therefore be of benefit to provide an apparatus and method for an automotive interior component combining motion deployment and lighting to augment the functionality and visual appeal of the automotive interior that provides advantages over known components and manufacturing methods.

### SUMMARY

The invention overcomes the drawbacks and deficiencies of the aforementioned automotive interior components by providing an apparatus and method for an automotive interior component that combines motion deployment and lighting, that allows ease of visible location by providing a location indicator for the driver or passenger to efficiently and safely locate a dock and an object therein, that includes a light source providing continuous illumination to the dock and object therein as the dock and object therein move from a holder for receiving the dock to a deployed position, that provides an automotive interior component that can be mounted on or within an automotive instrument panel, an automotive center console, an automotive overhead console, an automotive armrest, an automotive storage compartment, or another suitable automotive component, and that augments the visual and aesthetic appeal of the automotive interior.

In one of the advantageous embodiments of the invention, there is provided an automotive interior component. The automotive interior component comprises a dock for receiving an object, a holder for receiving the dock and configured to movably store the dock, and a light source operatively connected to the dock. The light source provides continuous illumination of the dock as the dock moves from the holder to a deployed position, allowing ease of visible location and augmenting visual appeal of an automotive interior.

In another one of the advantageous embodiments of the invention, there is provided an automotive interior component. The automotive interior component comprises a movable holder for receiving an object and a light source operatively connected to the movable holder. The light source provides continuous illumination of the movable holder as the movable holder moves to a deployed position, allowing ease of visible location and augmenting visual appeal of an automotive interior.

In another one of the advantageous embodiments of the invention, there is provided a method of manufacturing an automotive interior component. The method comprises the steps of providing an automotive instrument panel with a holder integrated therein, engaging a movable dock to the holder, the movable dock being configured for moving between within the automotive instrument panel and a deployed position, and lining the movable dock with a light source for lighting the movable dock.

In another one of the advantageous embodiments of the invention, there is provided a method of manufacturing an automotive interior component. The method comprises the steps of providing an automotive center console with a holder, engaging a movable dock to the holder, the movable dock being configured for moving between a stored position and a deployed position, and lining the movable dock with a light source for lighting the movable dock.

Additional features, advantages, and embodiments of the invention may be set forth or become apparent from consideration of the following detailed description, drawings, and claims. Moreover, it is to be understood that both the foregoing summary of the invention and the following detailed description are exemplary and intended to provide explanation without limiting the scope of the invention as claimed.

### BRIEF DESCRIPTION OF THE DRAWINGS

The disclosure can be better understood with reference to the following detailed description taken in conjunction with the accompanying drawings which illustrate preferred and exemplary embodiments, but which are not necessarily drawn to scale, wherein:

FIG. 1 is an illustration of a side view of an embodiment of an automotive interior component according to the invention, showing a dock in a stored position and a deployed position;

FIG. 2 is an illustration of a side view of the automotive interior component of FIG. 1 moving from a stored position to a deployed position;

FIG. 3 is another illustration of a side view of the automotive interior component of FIG. 1 moving from a stored position to a deployed position;

FIG. 4 is an illustration of a side view of another embodiment of the automotive interior component according to the invention moving from a stored position to a deployed position;

FIG. 5 is an illustration of a side view of another embodiment of the automotive interior component according to the invention moving from a stored position to a deployed position;

FIG. 6 is an illustration of a side view of a dock according to the invention;

FIG. 7 is an illustration of a front view of a dock according to the invention;

FIG. 8 is an illustration of an automotive interior having one of the embodiments of an automotive interior component according to the invention;

FIG. 9 is an illustration of an automotive interior having another one of the embodiments of an automotive interior component according to the invention;

FIG. 10 is an illustration of a flow diagram of one of the embodiments of the method of manufacturing an automotive interior component according to the invention; and,

FIG. 11 is an illustration of a flow diagram of another one of the embodiments of the method of manufacturing an automotive interior component according to the invention.

### DETAILED DESCRIPTION

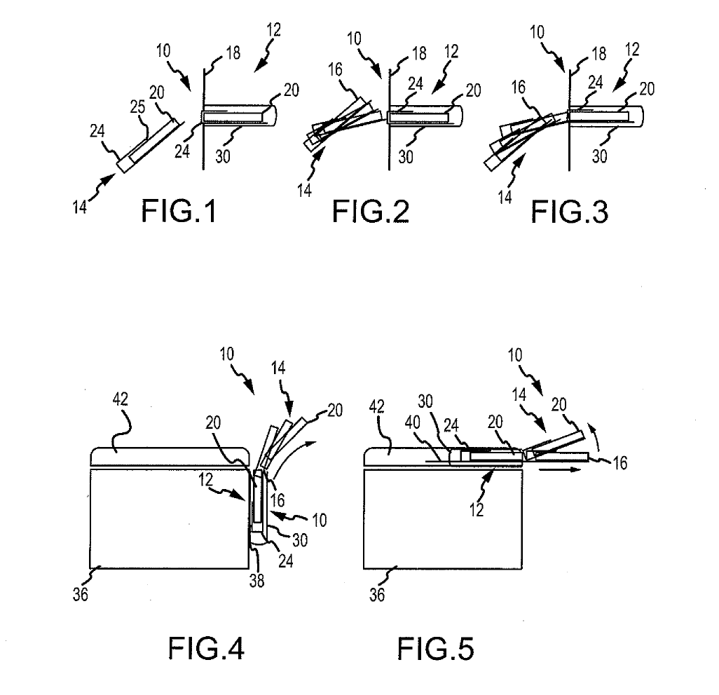

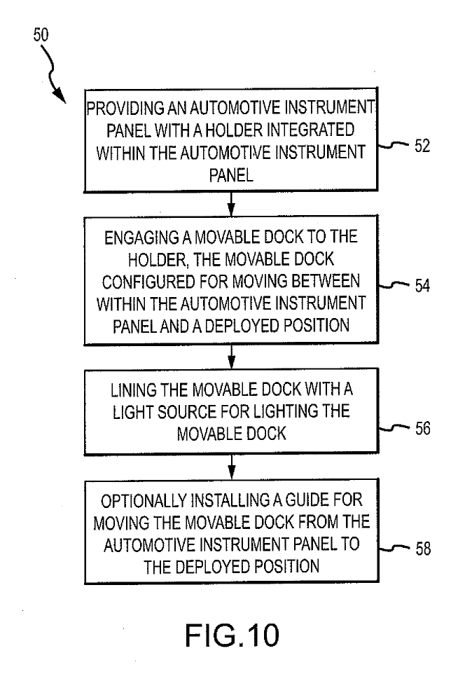

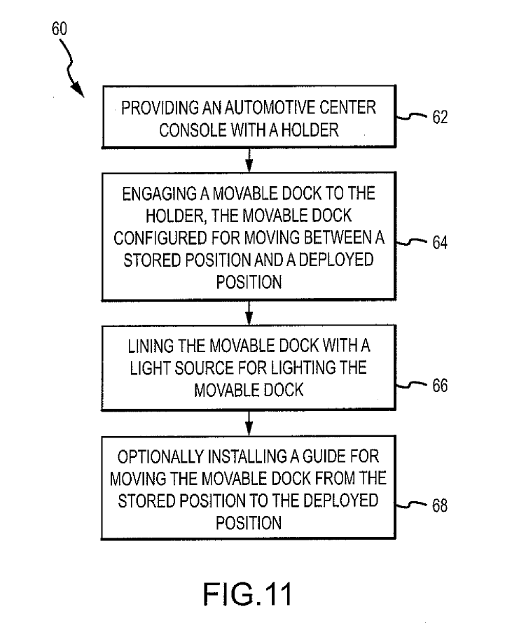

Turning now to the drawings wherein like reference characters refer to like and corresponding parts throughout the several views, FIGS. 1-9 illustrate various embodiments of an automotive interior component 10 combining light and movement. Embodiments of the method of the invention, as shown in FIGS. 10-11, may be used for making automotive interior components incorporating such components as a digital audio player dock and/or holder, a portable phone holder such as for wireless telephones, including analog or digital cellular phones, personal communication systems, or other portable transmitter/receiver devices used for personal communications, and other suitable automotive interior components that combine motion deployment and lighting, for use in automotive vehicles, trucks, and other suitable vehicles. Accordingly, one of ordinary skill in the art will recognize and appreciate that the apparatus and method of the disclosure can be used in any number of applications involving the manufacture of automotive interior components that combine motion deployment and lighting.

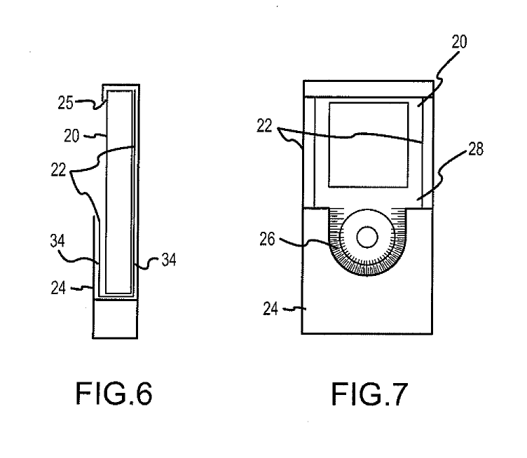

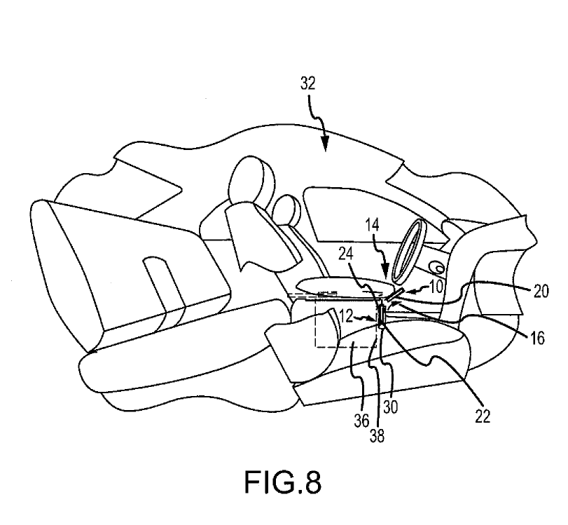

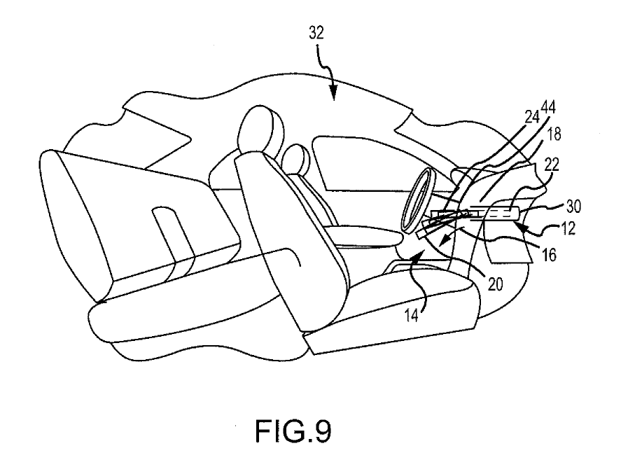

FIG. 1 shows one of the embodiments of an automotive interior component 10 of the invention. The automotive interior component 10 may comprise a dock 24, preferably a movable dock (see also FIGS. 6-7), for receiving an object 20 (see also FIGS. 6-7). The dock 24 may be of a rigid and sturdy structure and may have a receptacle cavity 25 for holding, storing, securing and retaining the object 20. The dock 24 may be made of plastic, metal, or another suitable material. The object 20 that may be stored and retained in the dock 24 may comprise a digital audio player 28 (see FIG. 7), such as an MP3 player, a portable phone (not shown) such as a wireless telephone, including analog or digital cellular phones, personal communication systems, or other portable transmitter/receiver devices used for personal communications, or another suitable object that can be held, stored, secured, and retained in the dock 24. FIG. 6 is an illustration of a side view of the dock 24 according to the invention. FIG. 6 shows the dock 24 of the automotive interior component 10 with the object 20 stored therein. The object 20 as shown in FIG. 6 may comprise a digital audio player 28, such as an MP3 player. FIG. 7 is an illustration of a front view of the dock 24 according to the invention. As shown in FIG. 1-3, the automotive interior component 10 further comprises a holder 30 for receiving the dock 24 and configured to movably store the dock 24. In one embodiment, the holder 30 may be integrated with or mounted within an automotive instrument panel 18 (see FIGS. 1-3 and FIG. 9). For example, the holder 30 may be integrated with or mounted within an automotive dashboard, a stereo console system, or another suitable area or component. As shown in FIG. 9, the holder 30 may be integrated with or mounted within a portion of the automotive instrument panel 18 or an instrument panel trim plate 44. In another embodiment, the holder 30 may be integrated with an automotive center console 36 (see FIGS. 4-5 and 8). For example, the holder 30 may be connected to an exterior portion 38 of the automotive center console 36 (see FIGS. 4 and 8), or the holder 30 may be integrated with or mounted within an interior portion 40 of a lid 42 the automotive center console 36 (see FIG. 5). The holder 30 may further be integrated with or mounted within an automotive overhead console (not shown), an automotive storage compartment (now shown), or another suitable automotive interior component.

The automotive interior component 10 further comprises a light source 22 (see FIGS. 6-8) operatively connected to the dock 24. The light source 22 may provide continuous illumination of the dock 24 as the dock 24 moves from the holder 30 to a deployed position 14 (see FIG. 8), allowing ease of visible location and augmenting visual and aesthetic appeal of an automotive interior 32 (see FIG. 8). The light source 22 may directly or indirectly illuminate the object 20 to be received and stored in the dock 24. The light source 22 may be located as shown in FIG. 6 on the dock 24, and may substantially line an interior 34 of the dock 24. By the light source 22 lining the interior 34 of the dock 24, the light source 22 may provide indirect lighting 26 to the object 20 stored within the dock 24. Indirect lighting 26 provided to the object 20 stored within the dock 24 may increase the ease of use for a driver (not shown) or passenger (not shown) in an automotive vehicle by allowing ready location of the object 20 stored within the dock 24. Indirect lighting 26 also provides an enhanced visual aesthetic appeal to the automotive interior 32. Further, when the object 20 stored within the dock 24 is not located in the dock 24, the light source 22 may also act as a location indicator for a driver or passenger to easily locate and use the dock 24. The light source 22 may comprise electroluminescent adhesive sheets, electroluminescent adhesive tapes, light emitting diodes (LEDs) with a light guide and diffuser, lightbulbs, or other suitable light sources.

FIG. 1 shows an illustration of a side view of an embodiment of the automotive interior component 10 according to the invention, showing the dock 24 in a stored position 12 and a deployed position 14. As shown in FIG. 1, the automotive interior component 10 may store the dock 24 and the object 20 therein in the stored position 12 and may deploy the dock 24 and the object 20 therein in the deployed position 14. The stored position 12 may be located behind an automotive instrument panel 18 or an instrument panel trim plate 44 (see also FIG. 9). Alternatively, the stored position 12 may be attached to another structure, such as an automotive center console 36 (see FIGS. 4-5 and 8). The deployed position 14 may be outside the automotive instrument panel 18 or the automotive center console 36. FIG. 2 is an illustration of a side view of the automotive interior component 10 of FIG. 1 showing movement 16 between the stored position 12 and the deployed position 14 and showing alternate combinations of rotational and translational movement between the stored position 12 and the deployed position 14. FIG. 3 is another illustration of a side view of the automotive interior component 10 of FIG. 1 showing movement 16 between the stored position 12 and the deployed position 14, such as complex movement combining rotation and translations between the stored position 12 and the deployed position 14.

FIG. 4 is an illustration of a side view of another embodiment of the automotive interior component 10 according to the invention, showing the dock 24 in the holder 30 in the stored position 12 and the deployed position 14 and showing movement 16 between the stored position 12 and the deployed position 14, such as complex movement combining rotation and translations between the stored position 12 and the deployed position 14. As shown in FIG. 4, the automotive interior component 10 may be mounted to an exterior portion 38 of the automotive center console 36. FIG. 5 is an illustration of a side view of another embodiment of the automotive interior component 10 according to the invention, showing the dock 24 in the holder 30 in the stored position 12 and the deployed position 14, such as complex movement combining rotation and translations between the stored position 12 and the deployed position 14. As shown in FIG. 5, the automotive interior component 10 may be mounted within an interior portion 40 of a lid 42 of the automotive center console 36. In these embodiments, the automotive interior component 10 may comprise the stored position 12 and the deployed position 14, and provides for movement 16 therebetween. The dock 24 may be received in or coupled to the holder 30 that provides for the movement between the stored position 12 and the deployed position 14 (see FIGS. 1-5). Movement 16 may be provided by guides (not shown) for the dock 24 to travel upon. Those skilled in the art can appreciate in view of this disclosure that the dock 24 may be broadly used as a holder for a variety of objects, such as, for example, instead of the dock 24, a holder may be used for storing or holding objects, with the holder thus functioning as the dock 24 as shown in FIGS. 1-9. Thus broadly, in a particular embodiment, the holder may have the same or similar function as the dock 24 for storing and/or holding objects.

FIG. 8 is an illustration of an automotive interior 32 having one of the embodiments of the automotive interior component 10 according to the invention. In this embodiment the automotive interior component 10 comprises a holder 30, preferably a movable holder, for receiving an object 20 and a light source 22 operatively connected to the holder 30, preferably a movable holder. The light source 22 provides continuous illumination of the holder 30, preferably a movable holder, as the movable holder 30 moves to the deployed position 14, which is preferably a use position, allowing ease of visible location and augmenting visual appeal of the automotive interior 32. The holder 30, preferably a movable holder, may be coupled to or connected to a dock 24, and the holder 30 provides for the movement 16 between the stored position 12 and the deployed position 14. Movement 16 may be provided by guides (not shown) for the holder 30, preferably a movable holder, to travel upon. As shown in FIG. 8, the automotive interior component 10 may be mounted to an exterior portion 38 of the automotive center console 36.

FIG. 9 is an illustration of an automotive interior 32 having another of the embodiments of the automotive interior component 10 according to the invention. In this embodiment the automotive interior component 10 comprises a holder 30, preferably a movable holder, for receiving an object 20 and a light source 22 operatively connected to the holder 30, preferably a movable holder. The light source 22 provides continuous illumination of the holder 30, preferably a movable holder, as the movable holder 30 moves to the deployed position 14, which is preferably a use position, allowing ease of visible location and augmenting visual appeal of the automotive interior 32. The holder 30, preferably a movable holder, may be coupled to or connected to a dock 24, and the holder 30 provides for the movement 16 between the stored position 12 and the deployed position 14. Movement 16 may be provided by guides (not shown) for the holder 30, preferably a movable holder, to travel upon. As shown in FIG. 9, the automotive interior component 10 may be integrated with or mounted within a portion of the automotive instrument panel 18, such as an instrument panel trim plate 44.

Those skilled in the art can appreciate that although the invention is illustrated for storing a digital audio player, such as an MP3 player, it is contemplated that the automotive interior component 10 may be configured to store a portable phone or other personal communications device, and/or function as a receptacle that combines movement and light to easily guide the driver or passenger to the component and simultaneously enhance the visual and aesthetic appeal of the automotive interior.

FIG. 10 is an illustration of a flow diagram of one of the embodiments of a method 50 of manufacturing an automotive interior component 10 according to the invention. The method 50 comprises step 52 of providing an automotive instrument panel 18 with a holder 30 integrated within the automotive instrument panel 18 (see FIGS. 1-3 and FIG. 9). The method 50 further comprises step 54 of engaging a movable dock 24 to the holder 30. The movable dock 24 is configured for moving from between a stored position 12 within the automotive instrument panel 18 and a deployed position 14 exterior to the automotive instrument panel 18. The method 50 further comprises step 56 of lining the movable dock 24 with a light source 22 for lighting the movable dock 24. The step 56 of lining the movable dock 24 may further comprise lining an interior 34 of the movable dock 24. The method 50 may optionally further comprise step 58 of installing one or more guides (not shown) for moving the movable dock 24 from the automotive instrument panel 18 to the deployed position 14. The light source 22 may also be operatively connected to the holder 30.

FIG. 11 is an illustration of a flow diagram of another one of the embodiments of a method 60 of manufacturing an automotive interior component 10 according to the invention. The method 60 comprises step 62 of providing an automotive center console 36 with a holder 30. The method 60 further comprises step 64 of engaging a movable dock 24 to the holder 30, the movable dock 24 configured for moving between a stored position 12 and a deployed position 14. The method 60 further comprises step 66 of lining the movable dock 24 with a light source 22 for lighting the movable dock 24. The step 66 of lining the movable dock 24 further comprises lining an interior 34 of the movable dock 24. The method 60 may optionally further comprise step 68 of installing one or more guides (not shown) for moving the movable dock 24 from the stored position 12 to the deployed position 14. The light source 22 may also be operatively connected to the holder 30.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. An automotive interior component comprising:
a dock for receiving an object;
a holder for receiving the dock and configured to movably store the dock; and,
a light source operatively connected to the dock;
wherein the light source provides continuous illumination of the dock as the dock moves from the holder to a deployed position, allowing ease of visible location and augmenting visual appeal of an automotive interior.

2. The automotive interior component of claim 1, wherein the light source comprises electroluminescent adhesive sheets, electroluminescent adhesive tapes, light emitting diodes (LEDs) with a light guide and diffuser, or lightbulbs.

3. The automotive interior component of claim 1, wherein the light source directly or indirectly illuminates the object to be received in the dock.

4. The automotive interior component of claim 1, wherein the holder is integrated within an automotive instrument panel.

5. The automotive interior component of claim 1, wherein the holder is integrated with an automotive center console.

6. The automotive interior component of claim 5, wherein the holder is connected to an exterior portion of the automotive center console.

7. The automotive interior component of claim 5, wherein the holder is integrated within a lid of the automotive center console.

8. An automotive interior component comprising.
a movable holder for receiving an object; and,
a light source operatively connected to the movable holder;
wherein the light source provides continuous illumination of the movable holder as the movable holder moves to a deployed position, allowing ease of visible location and augmenting visual appeal of an automotive interior.

9. The automotive interior component of claim 8, wherein the light source comprises electroluminescent adhesive sheets, electroluminescent adhesive tapes, light emitting diodes (LEDs) with a light guide and diffuser, or lightbulbs.

10. The automotive interior component of claim 8, wherein the light source directly or indirectly illuminates the object to be received in the movable holder.

11. The automotive interior component of claim 8, wherein the movable holder is integrated within an automotive instrument panel.

12. The automotive interior component of claim 8, wherein the movable holder is integrated with an automotive center console.

13. The automotive interior component of claim 12, wherein the movable holder is connected to an exterior portion of the automotive center console.

14. The automotive interior component of claim 12, wherein the movable holder is integrated within a lid of the automotive center console.

15. A method of manufacturing an automotive interior component comprising:
providing an automotive instrument panel with a holder integrated therein;
engaging a movable dock to the holder, the movable dock configured for moving between within the automotive instrument panel and a deployed position; and,
lining the movable dock with a light source for lighting the movable dock.

16. The method of claim 15, wherein lining the movable dock comprises lining an interior of the movable dock.

17. The method of claim 15, further comprising installing a guide for moving the movable dock from the automotive instrument panel to the deployed position.

18. A method of manufacturing an automotive interior component comprising:
providing an automotive center console with a holder;
engaging a movable dock to the holder, the movable dock configured for moving between a stored position and a deployed position; and,
lining the movable dock with a light source for lighting the movable dock.

19. The method of claim 18, wherein lining the movable dock further comprises lining an interior of the movable dock.

20. The method of claim 18, further comprising installing a guide for moving the movable dock from the stored position to the deployed position.
